(19) United States
(12) Patent Application Publication
(10) Pub. No.: US 2017/0356768 A1
(43) Pub. Date: Dec. 14, 2017

(54) Device Cover

(71) Applicant: Corey Carmicle, Cocoa, FL (US)

(72) Inventor: Corey Carmicle, Cocoa, FL (US)

(21) Appl. No.: 15/179,552

(22) Filed: Jun. 10, 2016

(51) Int. Cl. G01D 11/26

(52) U.S. Cl. CPC G01D 11/26

(57) ABSTRACT

A device cover including an upper portion, a lower portion, and a fastener is disclosed. The upper portion includes a top surface, upper sidewalls extending downwardly from a perimeter of the top surface, and a transparent section carried by the top surface. The lower portion includes a lower surface and lower sidewalls extending upwardly from a perimeter of the lower surface. The fastener has a first side connected to the upper portion and a second side connected to the lower portion. An attachment portion is positioned on an end portion of the fastener and connected to a portion of each the upper portion and the lower portion. The first and second sides of the fastener are cooperatively configured to secure to one another. The upper and lower portions are cooperatively adapted to form a void and to operably carry a device within the void.

### Field of the Invention

The present invention relates to systems for covering a lawn tool or metal detector. More specifically, the present invention is related to a water resistant device adapted to cover a lawn tool or metal detector while allowing operation of the lawn tool or metal detector.

### Background

Detection devices may be used in outdoor environments to detect objects placed in, on, or near the ground. Detection devices may be operated in contact with moisture or sharp objects such as rocks, roots, sticks, sprinkler heads, or the like, which may be located in or near the ground in an outdoor environment. These detection devices may be sensitive to moisture and abrasion, and may also provide a visual indication of the location of detected items.

U.S. Patent Publication No. 2014/0097831 to Whaley provides a system and method of shielding the head of a metal detector while reducing the effects of capacitance variation between the coils and their surroundings.

U.S. Pat. No. 5,680,048 to Wollny provides a detection device that is configured to detect metallic and non-metallic items.

U.S. Pat. No. 3,742,341 to Clowes et al. discloses a metal detector, which includes a light bulb to indicate the detection of metallic items.

U.S. Pat. No. 8,100,652 to Bauer et al. discloses a ceiling fan cover configure to protect the ceiling fans during periods of non-use.

None of the above references disclose structure to protect a detection device from the elements while allowing an operator to view a visual indicator on the detection device. Therefore, a need exists for a device which provides rugged, water resistant protection for a detection device while allowing an operator to view a visual indication provided by the detection device.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a device cover that advantageously allows an operator to view a visual indication provided by the detection device. The present invention also advantageously provides a device cover that is rugged, water resistant protection for a detection device.

These and other objects, features and advantages of the present invention are provided by a device cover that includes an upper portion, a lower portion, and a fastener. The upper portion may include a top surface, upper sidewalls extending downwardly from a perimeter of the top surface along an entirety of an upper connecting portion, and a transparent section carried by the top surface. The lower portion may include a lower surface and lower sidewalls extending upwardly from a perimeter of the lower surface along an entirety of a lower connecting portion.

The fastener may have a first side connected to the upper portion and a second side connected to the lower portion. The fastener may include an attachment portion positioned on an end portion thereof and connected to a portion of the upper portion and a portion of the lower portion. The first side of the fastener and the second side of the fastener may be cooperatively configured to secure to one another. The upper portion and the lower portion may be cooperatively adapted to form a void and to operably carry a device within the void.

The lower surface may include vinyl. The top surface may be arcuate and lower surface may be arcuate. The top surface may have a top diameter equal to a lower diameter of the lower surface. The first side of the fastener may include a first zipper half and the second side of the fastener may include a second zipper half.

The upper connecting portion may have a first length. The lower connection portion may have a second length equal to the first length. The first length may be greater than half the perimeter of the top surface. The first length may be greater than three-quarters of the perimeter of the top surface.

An upper opening may be formed along a portion of the perimeter of the top surface. The upper opening may be defined by the absence of an upper side wall. A lower opening may be formed along a portion of the perimeter of the lower surface. The lower opening may be defined by the absence of a lower side wall. The upper opening may have a length aligning with the lower opening along the entirety of the length.

The device cover may have a device cover height equal to a height of the upper sidewall plus a height of the lower sidewall. The device cover height may be less than one fourth the top diameter. The entirety of the top surface may be transparent. The entirety of the upper portion may be constructed from water resistant material. The entirety of the lower portion may be constructed from water resistant material.

### BRIEF DESCRIPTION OF THE DRAWINGS

FIG. 1 is a top perspective view of a device cover according to an embodiment of the present invention.

FIG. 2 is a top plan view of the device cover of FIG. 1 in an open configuration.

FIG. 3 is a top plan view of the device cover of FIG. 1 in a closed configuration.

FIG. 4 is a side elevation view of the device cover of FIG. 1 in a closed configuration.

FIG. 5 is an environmental view of the device cover of FIG. 1 positioned on a detection device.

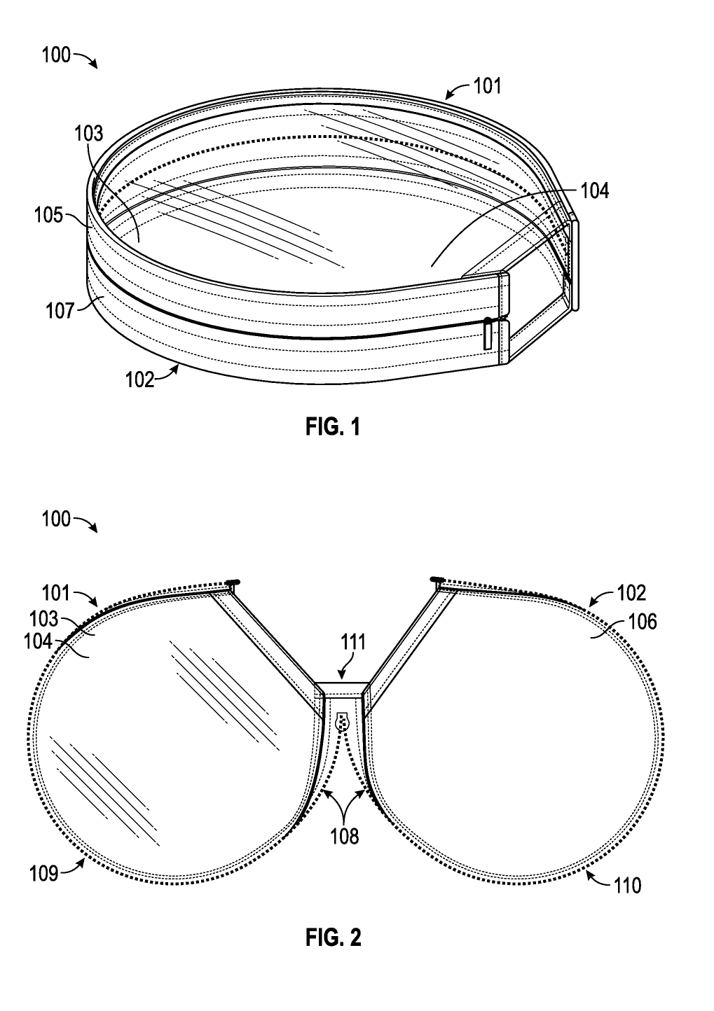

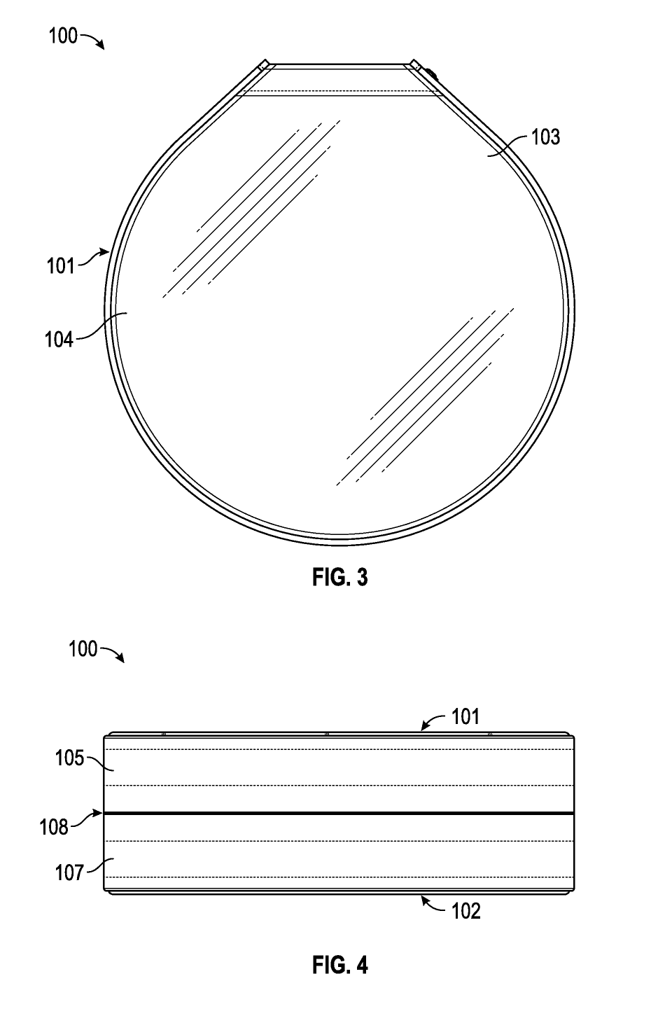

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

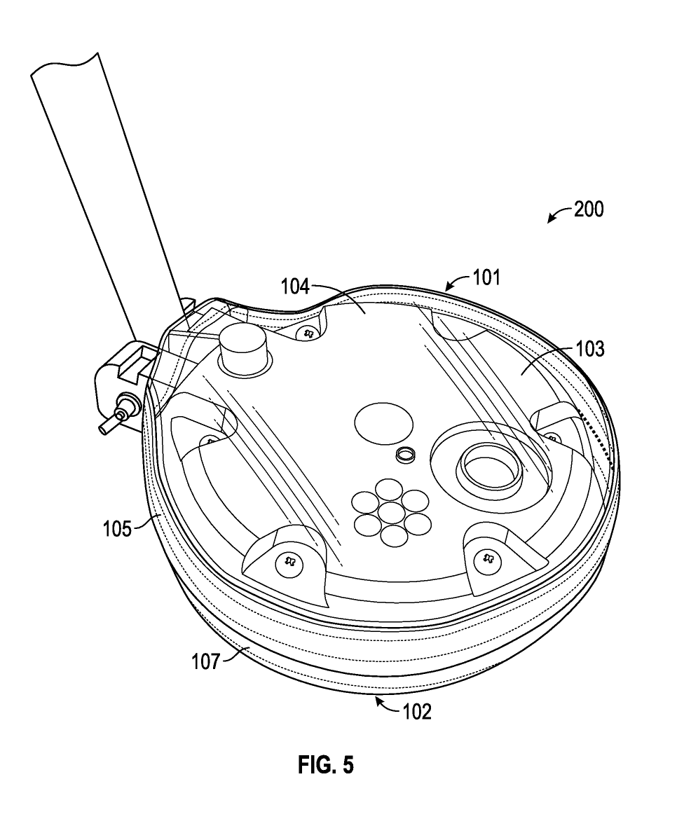

An embodiment of the invention, as shown and described by the various figures and accompanying text, provides a device cover 100 with an upper portion 101 and a lower portion 102. As depicted in FIG. 5, the device cover 100 may be adapted to enclose a detector head 200 of a detection device. The detection device may include, but is not limited to a metal detector, a metal pest control detector, or the like. The detection device may have a detector head 200, which may be located near or in contact with the ground when in an operable position. The detection device may also have a handle secured to the detector head 200, which may be held by an operator when in the operable position. A visual indicator may be located on the upper surface of the detector head 200. The visual indicator may change its visual appearance to indicate the presence of an object below or near the detector.

The upper portion 101 of the device cover 100 may be adapted to cover an upper surface of a detector head 200 of a detection device. The upper portion 101 may have a transparent section 103 adapted to cover the visual indicator, while allowing the detection device operator to view the visual indicator.

The upper portion 101 may be adapted to secure to a lower portion 102. The lower portion 102 may cover a lower surface of the detector head 200 of the detection device. The upper portion 101 and the lower portion 102 may be cooperatively adapted to form a void and operably carry the detector head 200 of the detection device within the void. The upper portion 101 may be constructed from water resistant material. The lower portion 102 may be constructed from water resistant material. The entirety of the lower portion 102 or upper portion 101 may be constructed from water resistant material. A fastener 108 may be utilized to join the upper portion 101 to the lower portion 102. The fastener 108 may form a water resistant connection when the device cover 100 is in a closed configuration. The device cover 100 may be configured to be water resistant when the upper portion 101 is joined to the lower portion 102 in a closed configuration.

The upper portion 101 may include a top surface 104. The top surface 104 may be configured to extend along or cover an entirety of the detector head's 200 upper surface. The top surface 104 may carry a transparent section 103. In one embodiment, the entirety of the top surface 104 may be constructed from a transparent material. In such an embodiment, the top surface 104 may be coextensive with the transparent section 103 and the top surface 104 may be said to carry a transparent section 103. The top surface 104 may be essentially arcuate. Essentially arcuate may be defined as a perimeter that is entirely arcuate or partially arcuate, i.e., arcuate except for a portion which is linear. The linear portion of the essentially arcuate perimeter may be adapted to align with a portion of the detection device where a handle is secured to a detector head 200. The top surface 104 may have a top diameter. The top diameter may extend in a straight line from one portion of an arcuate perimeter of the top surface 104, through a center of the top surface 104 and to an opposing portion of the arcuate perimeter.

The upper portion 101 may include upper sidewalls 105. The upper sidewalls 105 may be secured to a perimeter of the top surface 104. The upper sidewalls 105 may extend downwardly from the top surface 104 at a 90° angle. The upper sidewalls 105 may be secured to the top surface 104 along an entirety of an upper connection portion. The upper connecting portion may be defined as the portion of the top surface 104 to which the upper sidewall 105 is attached. The upper connecting portion may be defined as the portion of the upper portion 101 which is adapted to be secured to a lower portion 102 of the device cover 100. The upper connecting portion may be defined as the portion of the top surface 104 perimeter which is circular and not include a linear portion of the top surface 104 essentially arcuate perimeter.

The upper portion 101 may include an upper opening. The upper opening may be formed along a portion of the perimeter of the top surface 104 to which no upper sidewall 105 is secured. The upper opening may be defined by the absence of an upper sidewall 105. The upper opening may be located adjacent the linear portion of the essentially arcuate perimeter of the upper portion 101, along a perimeter of the top surface 104, and between the upper sidewalls 105.

The lower portion 102 may include a lower surface 106. The lower surface 106 may extend along or cover an entirety of the detector head's 200 bottom surface. The lower surface 106 may be ruggedized to resist wear or tear as it may contact the ground or sharp, abrasive objects. The lower surface 106 may include vinyl. In one embodiment, the lower surface 106 may be heat sealed vinyl. The vinyl may be PVC vinyl. In one embodiment, the entirety of the lower surface 106 may be constructed from vinyl. The lower surface 106 may be essentially arcuate. Essentially arcuate may be defined as a perimeter that is arcuate or mostly arcuate except for a portion which is linear. The linear portion of the essentially arcuate perimeter may be adapted to align with a portion of the detection device where a handle is secured to a detector head 200. The lower surface 106 may have a lower diameter. The lower diameter may be a straight line extending from one arcuate edge of the lower surface 106, through a center of the lower surface 106, and to an opposing arcuate edge of the lower surface 106. The lower diameter may be equal in length to the top diameter. The length and shape of the perimeter of the lower surface 106 may mirror the length and shape of the perimeter of the top surface 104.

The lower portion 102 may include lower sidewalls 107. The lower sidewalls 107 may be secured to a perimeter of the lower surface 106. The lower sidewalls 107 may extend upwardly from the lower surface 106 at a 90° angle. The lower sidewalls 107 may be secured to the lower surface 106 along an entirety of a lower connection portion. The lower connecting portion may be defined as the portion of the lower surface 106 to which the lower sidewall 107 is attached. The lower connecting portion may be defined as the portion of the lower portion 102 which is adapted to be secured to an upper portion 101 of the device cover 100. The lower connecting portion may be defined as the portion of the lower surface 106 perimeter which is arcuate and not include a linear portion of the lower surface 106 perimeter.

The lower portion 102 may include a lower opening. The lower opening may be formed along a portion of the perimeter of the lower surface 106 to which no lower sidewall 107 is secured. The lower opening may be defined by the absence of a lower sidewall 107. The lower opening may be adjacent the linear portion of the perimeter of the lower portion 102, along the lower surface 106 perimeter, and between the lower sidewalls 107. The lower opening may be located adjacent the entirety of the upper opening. The upper opening may have a length equal to a length of the lower opening. The upper opening may align with the lower opening along an entirety of the length of the upper opening. The lower opening and the upper opening may be cooperatively formed to allow a handle of the detection device to extend therethrough.

As indicated above, the fastener 108 may secure the upper portion 101 to the lower portion 102. The fastener 108 may have a first side 109 and a second side 110. The first side 109 may be connected to the upper portion 101. The second side 110 may be connected to the lower portion 102. The first side 109 and the second side 110 may be cooperatively configured to secure to one another. An attachment portion 111 of the fastener 108 may connect to both the first side 109 and the second side 110. The attachment portion 111 may be positioned on an end portion of the fastener 108. The attachment portion 111 may connect to a portion of the upper portion 101 and a portion of the lower portion 102.

In one embodiment, the fastener 108 may be a zipper. In such an embodiment, a first half of the zipper chain may be secured to a first half of the zipper tape. The first half of the zipper tape may be secured to the upper portion 101. The first half of the zipper chain in combination with the first half of the zipper tape may be a first zipper half and may define the first side 109. A second half of the zipper chain may be secured to a second half of the zipper tape. The second half of the zipper tape may be secured to the lower portion 102. The second half of the zipper chain in combination with the second half of the zipper tape may be a second zipper half and may define the second side 110. A slider may be positioned on the first and second halves of the zipper chain. The slider may be operable to connect and disconnect one half of the zipper chain to the opposing half of the zipper chain. The attachment portion 111 may be the bottom tape end of the zipper. The attachment portion 111 may include both the first and second halves of the zipper tape.

The fastener 108 may secure to the upper portion 101 along an entirety of a length of the upper connecting portion along the first half of the zipper tape. The fastener 108 may secure to the lower portion 102 along an entirety of a length of the lower connecting portion along the second half of the zipper tape. The upper connecting portion may extend along more than half the perimeter of the top surface 104. In one embodiment, the upper connecting portion may extend along more than three-quarters of the perimeter of the top surface. The length of the upper connection portion may be equal to the length of the lower connecting portion. Although a zipper is shown as the fastener 108, the skilled artisan will appreciate that the present invention contemplates the use of other fasteners such as, for example, hook and loop fasteners, snaps, buttons, or any other type of fastener that may be used to secure the upper portion to the lower portion.

The device cover 100 may have a device cover height. The device cover height may be equal to the height of the upper sidewall 105 extending orthogonal to the upper portion 101 plus the height of the lower sidewall 107 extending orthogonal to the lower surface 106. The device cover height may be less than one fourth the diameter of the upper portion, which may be a top diameter.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A device cover comprising:
an upper portion further comprising:
a top surface,
upper sidewalls extending downwardly from a perimeter of the top surface along an entirety of an upper connecting portion, and
a transparent section carried by the top surface;
a lower portion further comprising:
a lower surface and
lower sidewalls extending upwardly from a perimeter of the lower surface along an entirety of a lower connecting portion; and
a fastener having a first side connected to the upper portion and a second side connected to the lower portion, the fastener including an attachment portion positioned on an end portion thereof connected to a portion of the upper portion and a portion of the lower portion;
wherein the first side of the fastener and the second side of the fastener are cooperatively configured to secure to one another; and
wherein the upper portion and the lower portion are cooperatively adapted to form a void and to operably carry a device within the void.

2. The device cover according to claim 1 wherein the lower surface comprises vinyl.

3. The device cover according to claim 1 wherein the top surface is arcuate and lower surface is arcuate.

4. The device cover according to claim 3 wherein the top surface has a top diameter equal to a lower diameter of the lower surface.

5. The device cover according to claim 1 wherein the first side of the fastener comprises a first zipper half and the second side of the fastener comprises a second zipper half.

6. The device cover according to claim 1 wherein the upper connecting portion has a first length; wherein the lower connection portion has a second length equal to the first length; and wherein the first length is greater than half the perimeter of the top surface.

7. The device cover according to claim 6 wherein the first length is greater than three-quarters of the perimeter of the top surface.

8. The device cover according to claim 1 wherein an upper opening is formed along a portion of the perimeter of the top surface; wherein the upper opening is defined by the absence of an upper side wall; wherein a lower opening is formed along a portion of the perimeter of the lower surface; and wherein the lower opening is defined by the absence of a lower side wall.

9. The device cover according to claim 8 wherein the upper opening has a length and aligns with the lower opening along the entirety of the length.

10. The device cover according to claim 4 having a device cover height equal to a height of the upper sidewall plus a height of the lower sidewall;
wherein the device cover height is less than one fourth the top diameter.

11. The device cover according to claim 1 wherein the entirety of the top surface is transparent.

12. The device cover according to claim 1 wherein the entirety of the upper portion is constructed from water resistant material; and wherein the entirety of the lower portion is constructed from water resistant material.

13. A device cover comprising:
an upper portion further comprising:
an arcuate top surface having a top surface diameter,
upper sidewalls extending downwardly from a perimeter of the top surface along an entirety of an upper connecting portion having a connecting length greater than half the perimeter of the arcuate top surface, and
a transparent section carried by the top surface;
a lower portion further comprising:
an arcuate lower surface and
lower sidewalls extending upwardly from a perimeter of the arcuate lower surface along an entirety of a lower connecting portion,
wherein the lower portion has an arcuate lower surface diameter equal to the arcuate top surface diameter and
wherein the lower connecting portion has a length equal to the connecting length;
a fastener having a first side connected to the upper portion and a second side connected to the lower portion, the fastener including an attachment portion positioned on an end portion thereof connected to a portion of the upper portion and a portion of the lower portion;
an upper opening formed along a portion of the perimeter of the arcuate top surface, wherein the upper opening is defined by the absence of an upper side wall; and
a lower opening formed along a portion of the perimeter of the arcuate lower surface, wherein the lower opening is defined by the absence of a lower side wall;
wherein the first side of the fastener and the second side of the fastener are cooperatively configured to secure to one another;
wherein the upper portion and the lower portion are cooperatively adapted to form a void and to operably carry a device within the void; and
wherein the upper opening has a length and aligns with the lower opening along an entirety of the length.

14. The device cover according to claim 13 wherein the arcuate lower surface comprises vinyl.

15. The device cover according to claim 13 wherein the first side of the fastener comprises a first zipper half and the second side of the fastener comprises a second zipper half.

16. The device cover according to claim 13 wherein the connecting length is greater than three-quarters of the perimeter of the arcuate top surface.

17. The device cover according to claim 13 having a device cover height equal to a height of the upper side wall plus a height of the lower side wall;
wherein the device cover height is less than one fourth the top diameter.

18. The device cover according to claim 13 wherein the entirety of the arcuate top surface is transparent.

19. The device cover according to claim 13 wherein the entirety of the upper portion is constructed from water resistant material; and
wherein the entirety of the lower portion is constructed from water resistant material.

20. A device cover comprising:
an upper portion further comprising:
an arcuate top surface having a top surface diameter,
upper sidewalls extending downwardly from a perimeter of the top surface along an entirety of an upper connecting portion having a connecting length greater than three-quarters of the perimeter of the arcuate top surface, and
a transparent section carried by the top surface;
a lower portion further comprising:
an arcuate lower surface comprising vinyl,
lower sidewalls extending upwardly from a perimeter of the arcuate lower surface along an entirety of a lower connecting portion,
wherein the lower portion has an arcuate lower surface diameter equal to the arcuate top surface diameter and
wherein the lower connecting portion has a length equal to the connecting length;
a fastener having a first side connected to the upper portion and a second side connected to the lower portion, the fastener including an attachment portion positioned on an end portion thereof connected to a portion of the upper portion and a portion of the lower portion;
an upper opening formed along a portion of the perimeter of the arcuate top surface, wherein the upper opening is defined by the absence of an upper side wall and has a length; and
a lower opening formed along a portion of the perimeter of the arcuate lower surface, wherein the lower opening is defined by the absence of a lower side wall and has a length aligned with the upper opening length along the entirety of the upper opening length;
wherein the first side of the fastener and the second side of the fastener are cooperatively configured to secure to one another;
wherein the upper portion and the lower portion are cooperatively adapted to form a void and to operably carry a device within the void;
wherein the upper opening has a length and aligns with the lower opening along an entirety of the length;
wherein a device cover height is equal to a height of the upper side wall plus the height of the lower side wall; and
wherein the device cover height is less than one fourth the top diameter.
